(19) United States
(12) Patent Application Publication
(10) Pub. No.: US 2011/0026572 A1
(43) Pub. Date: Feb. 3, 2011

(54) BAUD RATE ERROR DETECTION CIRCUIT AND BAUD RATE ERROR DETECTION METHOD

(75) Inventor: Takashi Kitahara, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/822,887

(22) Filed: Jun. 24, 2010

(30) Foreign Application Priority Data
Jul. 29, 2009 (JP) 2009-176993

(51) Int. Cl. H04B 17/00

(52) U.S. Cl. 375/225

(57) ABSTRACT

A baud rate error detection circuit has an edge detector, a start bit sampling circuit and an abnormal waveform detection circuit. The edge detector receives sync-field used for adjusting a baud rate of serial communication, and generates an edge detection signal in response to an edge included in the sync-field. The start bit sampling circuit measures a bit width of a start bit of the sync-field based on the edge detection signal and an internal clock signal, and generates an expected value signal indicating the bit width of the start bit as an expected value. The abnormal waveform detection circuit measures an inter-edge width after the start bit based on the edge detection signal and the internal clock signal, and generates an abnormal waveform detection signal if an error between the inter-edge width and the expected value indicated by the expected value signal exceeds a predetermined allowable error range.

### INCORPORATION BY REFERENCE

This application is based upon and claims the benefit of priority from Japanese patent application No. 2009-176993, filed on Jul. 29, 2009, the disclosure of which is incorporated herein in its entirety by reference.

### BACKGROUND OF THE INVENTION

1. Field of the Invention

The present invention relates to a baud rate error detection technique in serial communication.

2. Description of Related Art

In recent years, an on-board network has been widespread which links together ECUs (Electronic Control Units) installed in an automobile. Known as a representative serial communication protocol of the on-board network are: a CAN (Controller Area Network) and a LIN (Local Interconnect Network). The LIN can be achieved at lower costs than the CAN, and is used for communication between devices that do not require as much band width and diverseness as the CAN. For example, the LIN is used for communication of information from various sensors.

An LIN communication system as a serial communication system typically consists of one master node and a plurality of slave nodes. Here, in order to match a baud rate between the master node and the slave nodes, “SYNC-FIELD” is prepared in the LIN protocol.

More specifically, when the master node starts communication with the slave node, a frame header transmitted from the master node to the slave node includes SYNC-BREAK-FIELD and the SYNC-FIELD. The SYNC-BREAK-FIELD is a signal of Low level (dominant level) of 13 bits or more. The slave node detects Low level of 11 bits or more to determine it the SYNC-BREAK-FIELD. A data value “0x55” (=01010101) is stored in the SYNC-FIELD following the SYNC-BREAK-FIELD. The slave node adjusts its own baud rate by using the SYNC-FIELD. That is, after detecting the SYNC-BREAK-FIELD, the slave node adjusts the baud rate based on the subsequent SYNC-FIELD and thereafter receives data at the adjusted baud rate.

Japanese Patent Publication JP-2007-324679A discloses a baud rate generator for serial communication used in the slave node. FIG. 1 is a block diagram showing a configuration including the baud rate generator 12A. FIG. 2 is a timing chart showing an operation of the baud rate generator 12A.

A clock generator 11 outputs an internal clock (system clock) 51 to a CPU 10 and the baud rate generator 12A. The CPU 10 executes various types of processing based on the internal clock 51. The baud rate generator 12A determines the baud rate based on the internal clock 51. An I/O interface 14 performs data transmission and reception in accordance with the baud rate determined by the baud rate generator 12A.

The baud rate generator 12A is provided with: an edge detector 21, an edge counter 22, a SYNC-FIELD measuring timer 23, a baud rate correction circuit 24A, a baud rate correction value storage register 25, a baud rate initial value setting register 26, a selector 27, a counter 28 and an agreement detection circuit 29. A serial data is input to the baud rate generator 12A through the I/O interface 14.

When the SYNC-BREAK-FIELD is input to the baud rate generator 12A, a SYNC-BREAK-FIELD detection signal 30 is input to the edge detector 21. In response to the SYNC-BREAK-FIELD detection signal 30, the edge detector 21 starts an operation of detecting falling edges in the serial data. When detecting a falling edge of a start bit of SYNC-FIELD 42, the edge detector 21 outputs a SYNC-FIELD start signal 31 to the edge counter 22 and the SYNC-FIELD measuring timer 23. After that, the edge detector 21 outputs an edge detection signal 40 to the edge counter 22 every time it detects a falling edge in the SYNC-FIELD 42.

In response to the SYNC-FIELD start signal 31, the edge counter 22 starts a count operation. More specifically, the edge counter 22 counts the edge detection signal 40 received from the edge detector 21. Upon counting the edge detection signal 40 four times after the reception of the SYNC-FIELD start signal 31 (refer to FIG. 2), the edge counter 22 outputs a SYNC-FIELD end signal 32 to the SYNC-FIELD measuring timer 23 and the baud rate correction circuit 24A.

The SYNC-FIELD measuring timer 23 measures time by counting the internal clock 51. More specifically, as shown in FIG. 2, the SYNC-FIELD measuring timer 23 measures a time (measured time 33) from the reception of the SYNC-FIELD start signal 31 to the reception of the SYNC-FIELD end signal 32. That is, the SYNC-FIELD measuring timer 23 measures an eight-bit period corresponding to the eight-bit SYNC-FIELD 42, and the measured time 33 becomes the number of clocks corresponding to the eight-bit period. The SYNC-FIELD measuring timer 23 notifies the baud rate correction circuit 24A of the obtained measured time 33.

The baud rate correction circuit 24A receives the SYNC-FIELD end signal 32 and calculates a baud rate correction value 34 based on the measured time 33. The baud rate correction value 34 is a parameter for correcting the baud rate and is equal to the number of clocks corresponding to ½-bit period. The baud rate correction circuit 24A stores the baud rate correction value 34 in the baud rate correction value storage register 25. The baud rate correction value storage register 25 outputs the baud rate correction value 34 to the selector 27.

Meanwhile, the CPU 10 previously stores a baud rate initial value 35 in the baud rate initial value setting register 26. Here, the baud rate initial value 35 is a “theoretical value” of the number of clocks corresponding to the ½-bit period and is previously calculated in such a manner as to agree with a baud rate of the master node. The baud rate initial value setting register 26 outputs the baud rate initial value 35 to the selector 27.

The CPU 10 outputs a baud rate selection signal 52 to the selector 27. In a case where the baud rate selection signal 52 is “0”, the selector 27 outputs the baud rate initial value 35 as a baud rate selection output 36 to the agreement detection circuit 29. On the other hand, in a case where the baud rate selection signal 52 is “1”, the selector 27 outputs the baud rate correction value 34 as the baud rate selection output 36 to the agreement detection circuit 29.

The counter 28 counts the internal clock 51 and outputs a count value 37 to the agreement detection circuit 29. The agreement detection circuit 29 outputs an agreement detection signal 38 to the I/O interface 14, at timing when the baud rate selection output 36 and the count value 37 agree with each other. That is, the agreement detection circuit 29 outputs the agreement detection signal 38 to the I/O interface 14 for every ½-bit period before or after the correction. The agreement detection signal 38 is frequency-divided by a frequency division circuit in the I/O interface 14, and thereby clock signals (sampling clock, shift clock etc.) required for the data transmission and reception are generated.

In this manner, the baud rate generator 12A of the slave node measures the eight-bit period by utilizing the SYNC-FIELD 42 transferred from the master node and corrects its own baud rate based on the eight-bit period.

### SUMMARY

The inventor of the present application has recognized the following points. In the case of the related technique shown in FIGS. 1 and 2, even when the slave node receives SYNC-FIELD having an abnormal waveform, it is overlooked. The reason is that the SYNC-FIELD is determined only by detecting the falling edge of the start bit and detecting the four falling edges thereafter. In this case, a waveform for each bit is not checked and thus an abnormal waveform is overlooked.

FIGS. 3 to 5 illustrate various examples of the abnormal waveform of the SYNC-FIELD. In the example shown in FIG. 3, a width of a High bit is too small. In the example shown in FIG. 4, a falling edge of noise is erroneously counted as the falling edge of the SYNC-FIELD. In the example shown in FIG. 5, not the defined signal but noises are counted. Such an abnormal waveform being overlooked leads to a baud rate error in the slave node.

In one embodiment of the present invention, a baud rate error detection circuit is provided. The baud rate error detection circuit has: an edge detector configured to receive sync-field used for adjusting a baud rate of serial communication, and to generate an edge detection signal in response to an edge included in the sync-field; a start bit sampling circuit configured to measure a bit width of a start bit of the sync-field based on the edge detection signal and an internal clock signal, and to generate an expected value signal that indicates the measured bit width of the start bit as an expected value; and an abnormal waveform detection circuit configured to measure, based on the edge detection signal and the internal clock signal, an inter-edge width that is a width between edges after the start bit, and to generate an abnormal waveform detection signal if an error between the inter-edge width and the expected value indicated by the expected value signal exceeds a predetermined allowable error range.

In another embodiment of the present invention, a baud rate error detection method is provided. The baud rate error detection method includes: (A) receiving sync-field used for adjusting a baud rate of serial communication; (B) generating an edge detection signal in response to an edge included in the sync-field; (C) measuring a bit width of a start bit of the sync-field based on the edge detection signal and an internal clock signal to generate an expected value signal that indicates the measured bit width of the start bit as an expected value; (D) measuring, based on the edge detection signal and the internal clock signal, an inter-edge width that is a width between edges after the start bit; and (E) generating an abnormal waveform detection signal, if an error between the inter-edge width and the expected value indicated by the expected value signal exceeds a predetermined allowable error range.

According to the present invention, it is possible to detect an abnormal waveform of the SYNC-FIELD.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration including a baud rate generator described in a related technique;

FIG. 2 is a timing chart showing an operation of the baud rate generator described in the related technique;

FIG. 3 is a timing chart showing an example of an abnormal waveform of the SYNC-FIELD;

FIG. 4 is a timing chart showing another example of an abnormal waveform of the SYNC-FIELD;

FIG. 5 is a timing chart showing still another example of an abnormal waveform of the SYNC-FIELD;

FIG. 6 is a block diagram showing a configuration of a slave node including a baud rate error detection circuit according to a first embodiment of the present invention;

FIG. 7 is a conceptual diagram for explaining an example of an operation of a down counter;

FIG. 8 is a timing chart showing an example of an operation of the baud rate error detection circuit according to the present embodiment;

FIG. 9 is a timing chart showing another example of an operation of the baud rate error detection circuit according to the present embodiment;

FIG. 10 is a timing chart showing still another example of an operation of the baud rate error detection circuit according to the present embodiment;

FIG. 11 is a block diagram showing a configuration of a salve node including a baud rate error detection circuit according to a second embodiment of the present invention; and

FIG. 12 is a block diagram showing a configuration of a slave node including a baud rate error detection circuit according to a third embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

In the present embodiment, let us consider an LIN communication system using an LIN communication protocol as an example of a serial communication system. Typically, the LIN communication system includes one master node and a plurality of slave nodes. The master node and the slave node each is exemplified by a microcomputer (MCU: Micro Controller Unit).

When the master node starts communication with the slave node, a frame header transmitted from the master node to the slave node includes the SYNC-BREAK-FIELD and the SYNC-FIELD. Formats of the SYNC-BREAK-FIELD and the SYNC-FIELD are specified by the LIN communication protocol.

More specifically, the SYNC-BREAK-FIELD is a signal of Low level (dominant level) of 13 bits or more. The slave node as a receiving equipment detects Low level of 11 bits or more to determine it the SYNC-BREAK-FIELD. A data value “0x55” (=01010101) is stored in the SYNC-FIELD following the SYNC-BREAK-FIELD. The slave node as the receiving equipment adjusts its own baud rate by using the SYNC-FIELD. That is, after detecting the SYNC-BREAK-FIELD, the slave node adjusts the baud rate based on the subsequent SYNC-FIELD and thereafter receives data at the adjusted baud rate.

Hereinafter, the slave node as the receiving equipment in the LIN communication system and a baud rate error detection circuit used in the slave node will be described in detail.

### 1. First Embodiment

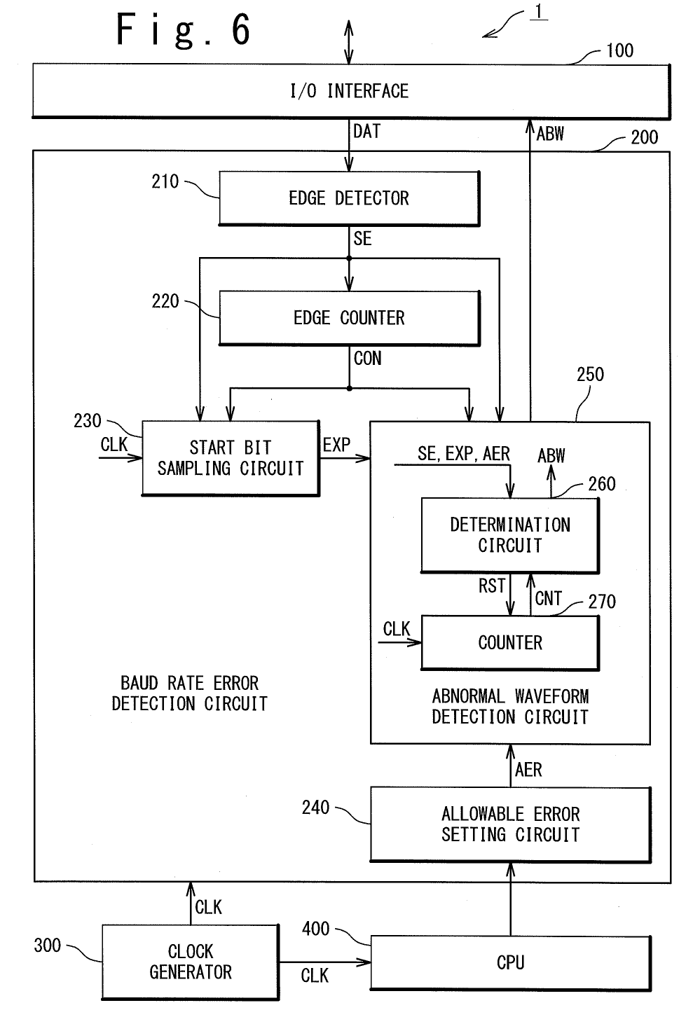

FIG. 6 is a block diagram showing a configuration of a slave node 1 according to a first embodiment of the present invention. The slave node 1 is provided with: an I/O interface 100, a baud rate error detection circuit 200, a clock generator 300 and a CPU 400.

The I/O interface 100 performs data transmission and reception to and from the master node and the other slave nodes through a bus. A serial data DAT including the SYNC-FIELD is input to the baud rate error detection circuit 200 through the I/O interface 100. The clock generator 300 generates an internal clock signal CLK (system clock) and supplies the internal clock signal CLK to the CPU 400 and the baud rate error detection circuit 200. The CPU 400 executes various types of processing based on the internal clock signal CLK.

The baud rate error detection circuit 200 receives the serial data DAT including the SYNC-FIELD through the I/O interface 100. The baud rate error detection circuit 200 is provided with: an edge detector 210, an edge counter 220, a start bit sampling circuit 230, an allowable error setting circuit 240 and an abnormal waveform detection circuit 250.

When the SYNC-BREAK-FIELD in the serial data DAT is detected by a circuit (not shown), the edge detector 210 is activated. The edge detector 210 receives the serial data DAT and performs edge detection. More specifically, the edge detector 210 generates an edge detection signal SE in response to an edge (rising edge, falling edge) in the SYNC-FIELD included in the serial data DAT. Then, the edge detector 210 outputs the edge detection signal SE to the edge counter 220, the start bit sampling circuit 230 and the abnormal waveform detection circuit 250.

When the SYNC-BREAK-FIELD in the serial data DAT is detected by the circuit (not shown), the edge counter 220 is initialized. The edge counter 220 counts the number of the edge detection signals SE received from the edge detector 210. That is, the edge counter 220 refers to the edge detection signal SE to count the number of edges detected by the edge detector 210.

By referring to the number of detected edges, it is possible to recognize start/end of a start bit of the SYNC-FIELD and end of the SYNC-FIELD. The edge counter 220 generates a control signal CON, depending on the number of detected edges. The control signal CON is a signal for controlling operations of the start bit sampling circuit 230 and the abnormal waveform detection circuit 250, and is transmitted to the start bit sampling circuit 230 and the abnormal waveform detection circuit 250.

For example, when the number of detected edges becomes 1, this means the start of the start bit of the SYNC-FIELD. At this time, the edge counter 220 generates the control signal CON that actives the start bit sampling circuit 230 and deactivates the abnormal waveform detection circuit 250. When the number of detected edges becomes 2, this means the end of the start bit of the SYNC-FIELD. At this time, the edge counter 220 generates the control signal CON that deactivates the start bit sampling circuit 230 and activates the abnormal waveform detection circuit 250. When the number of detected edges becomes a predetermined number corresponding to a predetermined number of bits of the SYNC-FIELD, this means the end of the SYNC-FIELD. At this time, the edge counter 220 generates the control signal CON that deactivates the abnormal waveform detection circuit 250.

The start bit sampling circuit 230 receives the edge detection signal SE from the edge detector 210 and receives the internal clock signal CLK from the clock generator 300. The start bit sampling circuit 230 measures a bit width of the start bit of the SYNC-FIELD, based on the edge detection signal SE and the internal clock signal CLK.

More specifically, the start bit sampling circuit 230 has a counter that performs a count operation in synchronization with the internal clock signal CLK. Upon receiving the first edge detection signal SE, the start bit sampling circuit 230 starts the count operation. Upon receiving the following second edge detection signal SE, the start bit sampling circuit 230 stops the count operation. A count value at this time corresponds to a period between the first and second edge detection signals SE, namely, the bit width of the start bit. In this manner, the start bit sampling circuit 230 can measure the bit width of the start bit of the SYNC-FIELD.

According to the present embodiment, the bit width (count value) of the start bit thus obtained is used as an “expected value” of a bit width of each of the subsequent bits of the SYNC-FIELD. To this end, the start bit sampling circuit 230 generates an expected value signal EXP that indicates the bit width of the start bit as the “expected value”. Then, the start bit sampling circuit 230 outputs the expected value signal EXP to the abnormal waveform detection circuit 250.

Meanwhile, an “allowable error value of the bit width” described later is stored in the allowable error setting circuit 240. The allowable error value is determined by the CPU 400 and previously stored in the allowable error setting circuit 240. The allowable error setting circuit 240 outputs an allowable error signal AER indicating the allowable error value to the abnormal waveform detection circuit 250.

The abnormal waveform detection circuit 250 receives the edge detection signal SE from the edge detector 210, the internal clock signal CLK from the clock generator 300, the expected value signal EXP from the start bit sampling circuit 230, and the allowable error signal AER from the allowable error setting circuit 240. The abnormal waveform detection circuit 250, based on the edge detection signal SE and the internal clock signal CLK, measures an inter-edge width that is a width between the edges after the start bit. Then, the abnormal waveform detection circuit 250 determines whether or not an error between the measured inter-edge width (bit width of the subsequent bit) and the expected value indicated by the expected value signal EXP exceeds an allowable error range specified by the allowable error signal AER. If the error is determined to exceed the allowable error range, the abnormal waveform detection circuit 250 generates an abnormal waveform detection signal ABW and outputs it to the outside.

More specifically, the abnormal waveform detection circuit 250 includes a determination circuit 260 and a counter 270. In response to the edge detection signal SE, the determination circuit 260 outputs a reset signal RST to the counter 270 to reset a count value of the counter 270 to an initial value. The counter 270 performs a count operation in synchronization with the internal clock signal CLK and generates a count value signal CN indicating the count value. The determination circuit 260 performs “determination processing” by referring to the count value signal CNT.

The determination processing is as follows. The inter-edge width (bit width of the subsequent bit) of the SYNC-FIELD corresponds to a period between the successive edge detection signals SE. That is, the inter-edge width corresponds to a difference between the initial count value and a count value at a time when the determination circuit 260 receives the edge detection signal SE. Therefore, the determination circuit 260 can obtain the inter-edge width of the SYNC-FIELD, by referring to the edge detection signal SE and the count value signal CNT. Furthermore, the determination circuit 260 can determine whether or not the error between the inter-edge width and the expected value indicated by the expected value signal EXP exceeds the allowable error range specified by the allowable error signal AER. If the error exceeds the allowable error range, the determination circuit 260 generates the abnormal waveform detection signal ABW and outputs it to the outside.

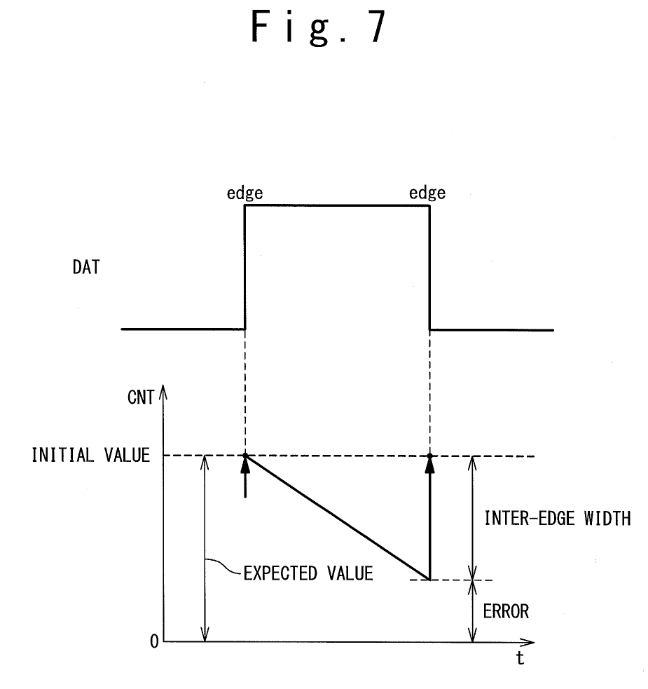

A case where the counter 270 is a “down counter” will be described with reference to FIG. 7. In this case, the determination circuit 260 sets the initial value of the down counter 270 to the expected value (the bit width of the start bit) indicated by the expected value signal EXP. The down counter 270 performs down-count operation in synchronization with the internal clock signal CLK. The inter-edge width corresponds to a difference between the initial value (expected value) and a count value at a time when the next edge detection signal SE is received. As a result, the error between the inter-edge width and the expected value is equal to the count value itself at the time when the next edge detection signal SE is received. Therefore, the determination circuit 260 can easily perform the determination processing by referring to the edge detection signal SE, the count value signal CNT and the allowable error signal AER.

It should be noted that the counter 270 may be an up-counter. In this case, the initial value is set to 0. The inter-edge width corresponds to a count value at a time when the edge detection signal SE is received. In this case, the determination circuit 260 calculates, as the above-mentioned error, a difference between the expected value indicated by the expected value signal EXP and the count value indicated by the count value signal CNT.

Hereinafter, an operation example in the case where the counter 270 is the down counter will be described.

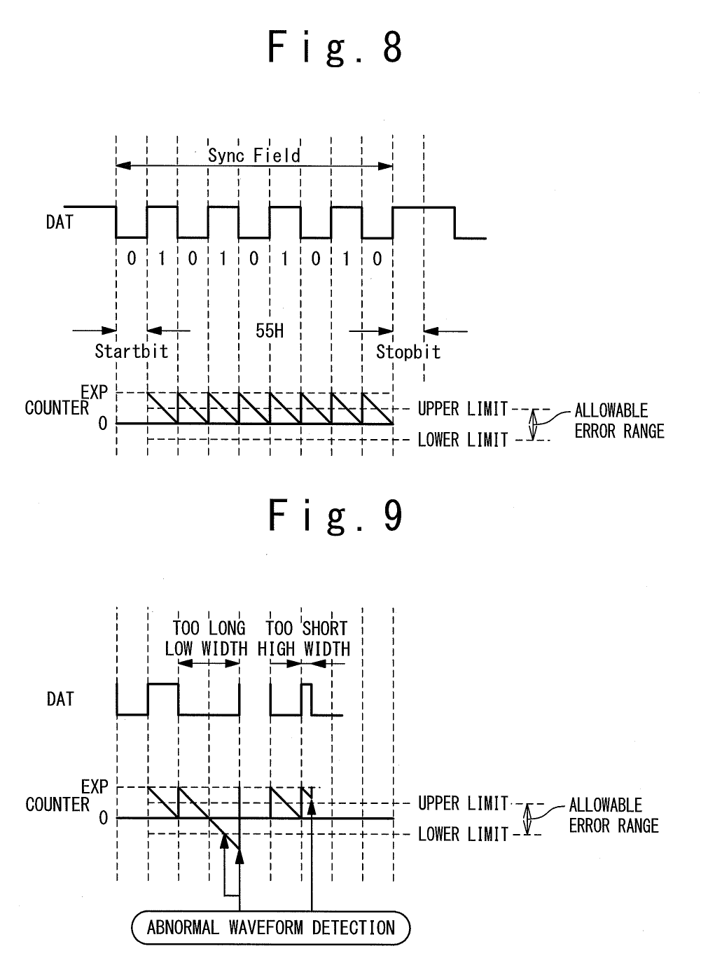

As shown in FIG. 8, the down counter 270 starts the down-count operation from a rising edge at the end of the start bit. The initial value of the down counter 270 is the expected value (the bit width of the start bit) obtained by the start bit sampling circuit 230. The determination circuit 260 performs the determination processing for each inter-edge width after the start bit. More specifically, the determination circuit 260 determines whether or not the count value at the time of the edge detection is included in the allowable error range.

FIG. 8 shows a case where the SYNC-FIELD has an ideal waveform. In this case, the count value at the time of the edge detection is included in the allowable error range. In other words, the next edge is detected within a period during which the count value is included in the allowable error range. Therefore, the determination circuit 260 determines that a waveform of the SYNC-FIELD is normal and resets the down counter 270. The same operation is repeated until the SYNC-FIELD ends.

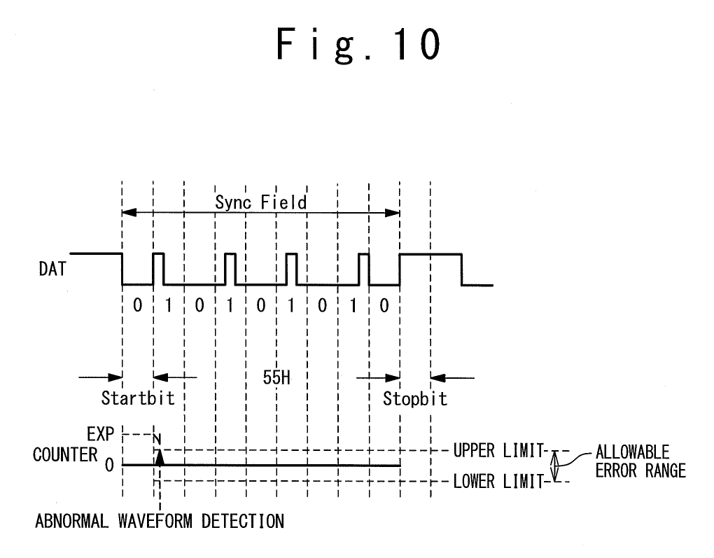

FIG. 9 shows, as examples of the abnormal waveform of the SYNC-FIELD, a case where the Low width is too long and a case where the High width is too short. In these cases, the count value at the time of the edge detection exceeds the allowable error range. In other words, the next edge is not detected within a period during which the count value is included in the allowable error range. Therefore, the determination circuit 260 determines that a waveform of the SYNC-FIELD is abnormal and outputs the abnormal waveform detection signal ABW.

It should be noted that, as shown in the example of FIG. 9, when the count value falls below the lower limit of the allowable error range, the abnormal waveform is obvious without waiting for the next edge detection. Therefore, the determination circuit 260 may generate and output the abnormal waveform detection signal ABW at the time when the count value indicated by the count value signal CNT falls below the lower limit of the allowable error range.

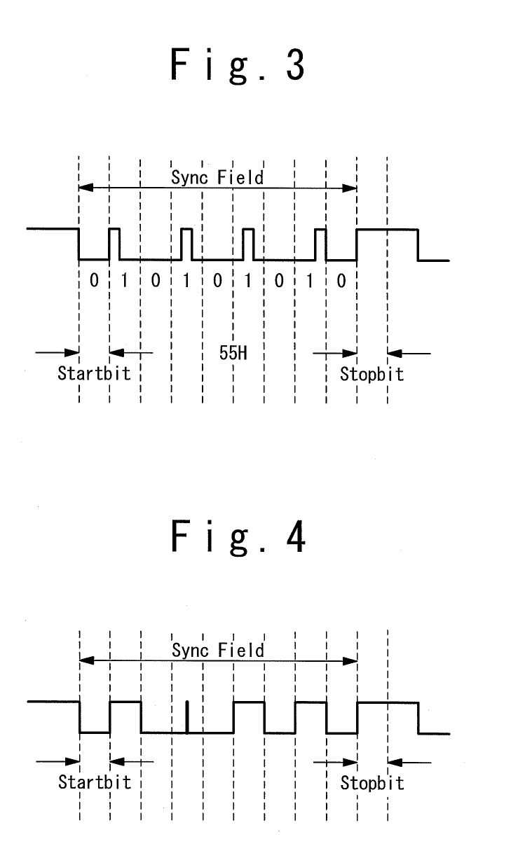

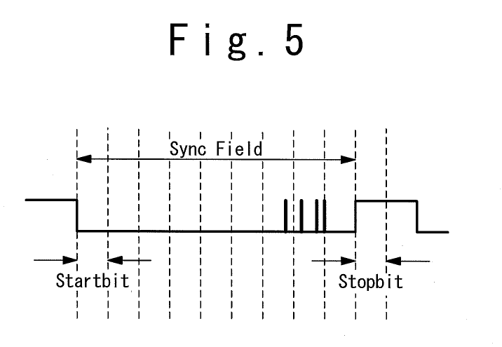

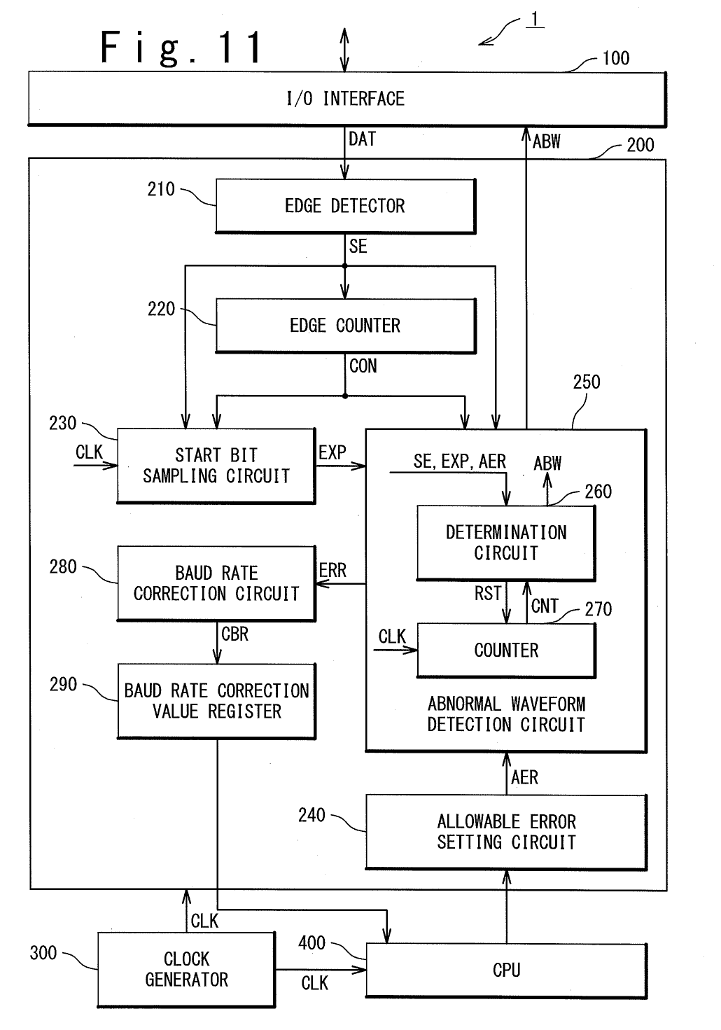

FIG. 10 shows a case of the same abnormal waveform as in the foregoing FIG. 3. As shown in FIG. 10, the abnormal waveform is detected at a time of a High bit next to the start bit. That is to say, an abnormality can be quickly detected without measuring the entire SYNC-FIELD.

As described above, according to the present embodiment, the start bit of the SYNC-FIELD is automatically sampled and its bit width is generated as the expected value. Then, a bit width is compared with the expected value for each of the subsequent bits. As a result, an abnormal waveform of the SYNC-FIELD can be detected.

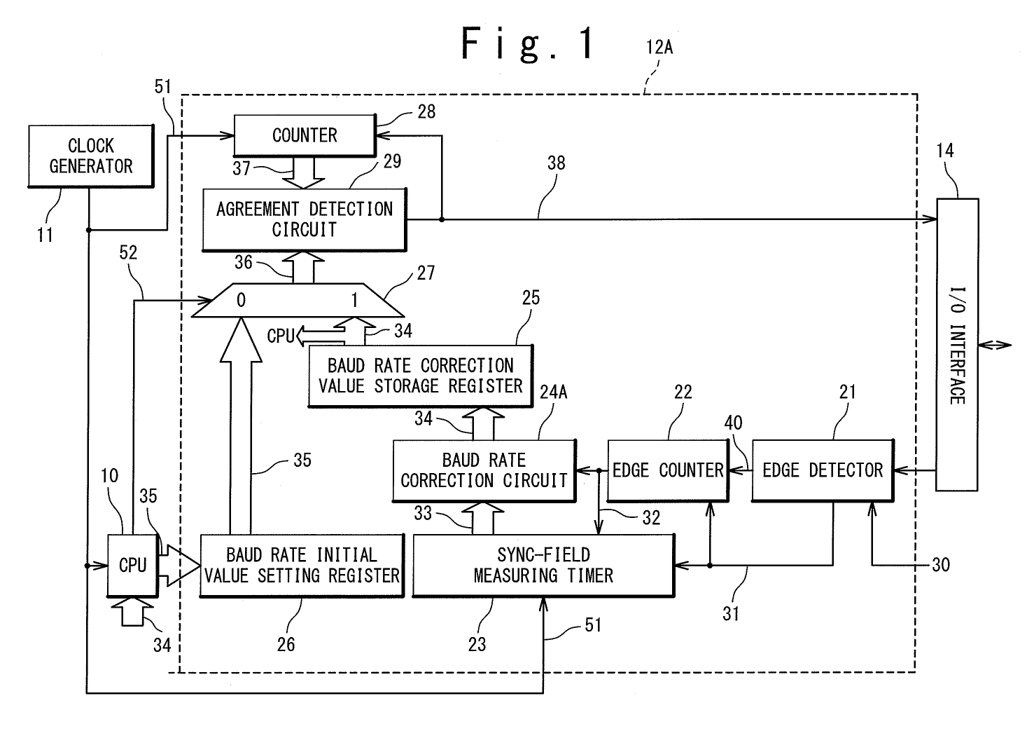

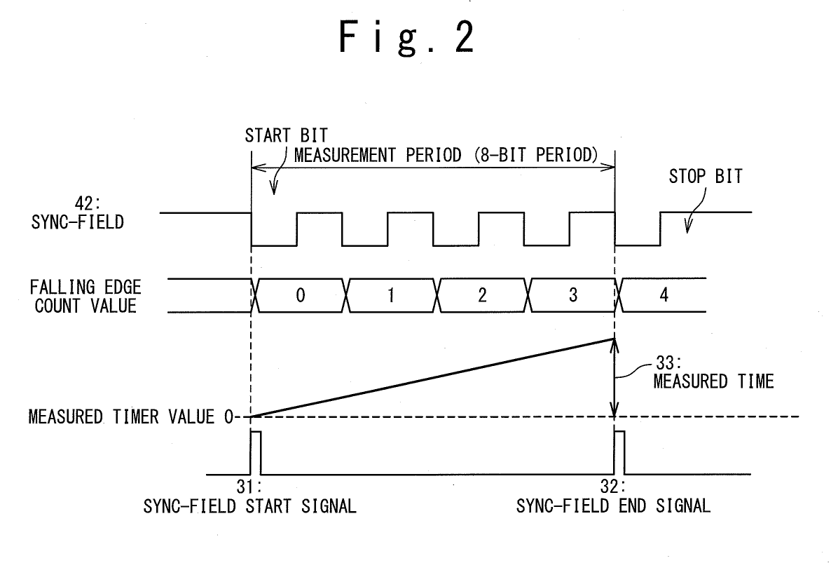

Moreover, according to the present embodiment, the bit width of the start bit as the expected value can be obtained automatically, and thus the baud rate initial value setting register 26 as shown in FIG. 1 is not necessary. This contributes to reduction in a circuit size.

Furthermore, the SYNC-FIELD measuring timer 23 shown in FIG. 1 is required to measure at least eight-bit period. On the other hand, the counter 270 used in the present embodiment just needs to measure a period of two normal bits at most. This also contributes to reduction in the circuit size.

### 2. Second Embodiment

FIG. 11 shows a configuration according to a second embodiment of the present invention. The baud rate error detection circuit 200 according to the second embodiment is further provided with a baud rate correction circuit 280 and a baud rate correction value register 290, in addition to the configuration according to the first embodiment. Description overlapping with that of the first embodiment will be omitted as appropriate.

In the present embodiment, the abnormal waveform detection circuit 250 generates an error signal ERR that indicates the above-mentioned error between the inter-edge width and the expected value. Then, the abnormal waveform detection circuit 250 sequentially outputs the generated error signal ERR to the baud rate correction circuit 280.

The baud rate correction circuit 280 stores the received error signal ERR in its own register. At a timing when the reception of the SYNC-FIELD is completed, the baud rate correction circuit 280 performs correction of the baud rate based on the error signal ERR. There are various possible baud rate correction methods. By the correction of the baud rate, a baud rate correction value CBR is obtained. The baud rate correction circuit 280 stores the obtained baud rate correction value CBR in the baud rate correction value register 290. The baud rate correction value register 290 retains the baud rate correction value CBR.

The CPU 400 reads out the baud rate correction value CBR from the baud rate correction value register 290. Based on the baud rate correction value CBR, the CPU 400 updates the above-described allowable error value. That is, the CPU 400 refers to the baud rate correction value CBR to determine the allowable error value to be used when receiving the next SYNC-FIELD. Then, the CPU 400 newly stores the determined allowable error value in the allowable error setting circuit 240. In this manner, the allowable error range used in the abnormal waveform detection processing is updated. As a result, accuracy of the abnormal waveform detection in an actual communication state is improved.

### 3. Third Embodiment

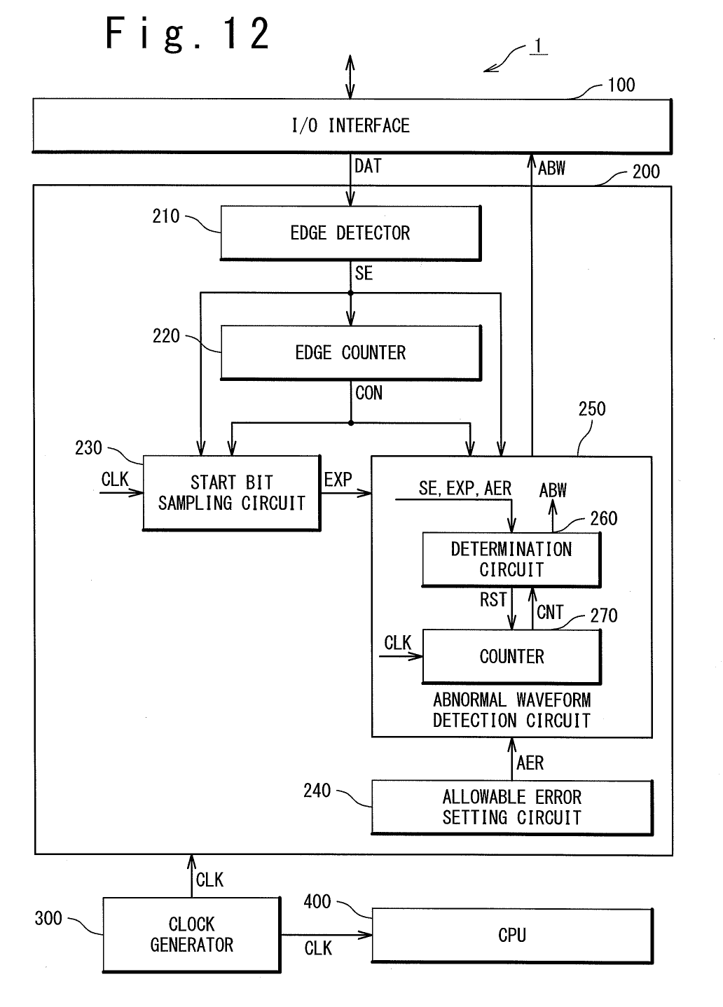

FIG. 12 shows a configuration according to a third embodiment of the present invention. In the third embodiment, the allowable error value stored in the allowable error setting circuit 240 is a fixed value. The CPU 400 does not perform the setting/updating of the allowable error value. The fixed value as the allowable error value is previously stored in the allowable error setting circuit 240. The others are the same as in the case of the first embodiment.

The embodiments of the present invention have been described above referring to the accompanying drawings. Note that, however, the present invention is not limited to the aforementioned embodiments, and thus modification can be made by those skilled in the art within a range not departing from spirits of the present invention.

What is claimed is:

1. A baud rate error detection circuit comprising:
an edge detector configured to receive sync-field used for adjusting a baud rate of serial communication, and to generate an edge detection signal in response to an edge included in said sync-field;
a start bit sampling circuit configured to measure a bit width of a start bit of said sync-field based on said edge detection signal and an internal clock signal, and to generate an expected value signal that indicates said measured bit width of said start bit as an expected value; and
an abnormal waveform detection circuit configured to measure, based on said edge detection signal and said internal clock signal, an inter-edge width that is a width between edges after said start bit, and to generate an abnormal waveform detection signal if an error between said inter-edge width and said expected value indicated by said expected value signal exceeds a predetermined allowable error range.

2. The baud rate error detection circuit according to claim 1,
wherein said start bit sampling circuit performs count operation in synchronization with said internal clock signal and obtains as said expected value a count value corresponding said bit width of said start bit,
wherein said abnormal waveform detection circuit comprises:
a counter configured to perform count operation in synchronization with said internal clock signal to generate a count value signal indicating a count value; and
a determination circuit configured to reset said count value of said counter to an initial value in response to said edge detection signal,
wherein said inter-edge width corresponds to a difference between said initial value and said count value indicated by said count value signal at a time when said determination circuit receives said edge detection signal, and
wherein said determination circuit refers to said count value signal and generates said abnormal waveform detection signal when said error between said inter-edge width and said expected value exceeds said predetermined allowable error range.

3. The baud rate error detection circuit according to claim 2,
wherein said counter is a down counter that performs down-count operation in synchronization with said internal clock signal,
said initial value is said expected value indicated by said expected value signal, and
said error between said inter-edge width and said expected value is said count value indicated by said count value signal at a time when said determination circuit receives said edge detection signal.

4. The baud rate error detection circuit according to claim 3,
wherein said determination circuit generates said abnormal waveform detection signal also when said count value indicated by said count value signal falls below a lower limit of said predetermined allowable error range.

5. The baud rate error detection circuit according to claim 1, further comprising:
a baud rate correction circuit configured to correct said baud rate based on said error between said inter-edge width and said expected value; and
a baud rate correction value register configured to retain a baud rate correction value obtained by said baud rate correction circuit.

6. The baud rate error detection circuit according to claim 5,
wherein said predetermined allowable error range is updated by a CPU based on said baud rate correction value.

7. The baud rate error detection circuit according to claim 1, further comprising:
an edge counter configured to count, based on said edge detection signal, a number of edges detected by said edge detector,
wherein said edge counter activates said abnormal waveform detection circuit upon end of said start bit and deactivates said abnormal waveform detection circuit upon end of said sync-field.

8. A baud rate error detection method comprising:
receiving sync-field used for adjusting a baud rate of serial communication;
generating an edge detection signal in response to an edge included in said sync-field;
measuring a bit width of a start bit of said sync-field based on said edge detection signal and an internal clock signal to generate an expected value signal that indicates said measured bit width of said start bit as an expected value;
measuring, based on said edge detection signal and said internal clock signal, an inter-edge width that is a width between edges after said start bit; and
generating an abnormal waveform detection signal, if an error between said inter-edge width and said expected value indicated by said expected value signal exceeds a predetermined allowable error range.
